(19) United States
(12) Patent Application Publication
(10) Pub. No.: US 2026/0091454 A1
(43) Pub. Date: Apr. 2, 2026

(54) Metallic Sealing Tape for Brazing and Brazing Methods

(71) Applicant: Eric Huesca, Temecula, CA (US)

(72) Inventor: Eric Huesca, Temecula, CA (US)

(21) Appl. No.: 18/904,239

(22) Filed: Oct. 2, 2024

(51) Int. Cl. B23K 35/02; B23K 1/20; B23K 35/30; B23K 101/10; B23K 103/12

(52) U.S. Cl. CPC B23K 35/0233; B23K 1/203; B23K 35/302; B23K 2101/10; B23K 2103/12

(57) ABSTRACT

A metallic sealing tape has a metallic layer and a layer of a pressure-sensitive adhesive disposed on one side of the metallic layer. The metallic layer is comprised of a brazing alloy, and may, e.g., comprise a thin foil of the brazing alloy. The brazing alloy may be, e.g., a copper-phosphorus alloy or a copper-phosphorus-silver alloy. A method for using the metallic sealing tape includes sealing a joint between two pipes with the metallic sealing tape and brazing the joint without removing the metallic sealing tape. The brazing may include heating the metallic sealing tape and may also include adding additional filler metal to the joint.

### TECHNICAL FIELD

Embodiments of the invention relate to a metallic sealing tape for brazing and to brazing methods using the tape.

### BACKGROUND

Plumbers use a variety of tools and methods to connect segments of pipe to make a functional plumbing system. Copper pipe is commonly used in many plumbing applications, and the brazing alloy used to join the pipe varies depending on the situation and application. The precise methods that are used in any plumbing job typically depend on industry best practices, local building codes, and national standards, with some types of plumbing subject to special codes or standards.

Medical gas systems are among the types of plumbing subject to special codes and standards. These systems are used in hospitals and in medical and dental offices to convey gases like oxygen and nitrous oxide, as well as to supply vacuum suction. Because poor installation could cause fires or harm patient health, standards like NFPA 99, promulgated by the National Fire Protection Association, apply to medical gas systems. Among other things, this standard requires that during brazing, joints are continuously purged with low-pressure dry nitrogen in order to avoid the formation of copper oxides along the interior of the joint. As a practical matter, it may also be necessary to test the patency of the joints and connections before brazing.

For these reasons, the typical practice with a medical gas system is to fit pipes together and temporarily seal joints before brazing. Typically, electrical tape is wrapped around joints to seal them temporarily. This results in additional work, as each joint must be unwrapped and the tape discarded before the joint can be brazed.

### BRIEF SUMMARY

One aspect of the invention relates to a metallic sealing tape. The metallic sealing tape includes a metallic layer comprising a brazing alloy, and a layer of pressure-sensitive adhesive on one side of the metallic layer. The metallic layer may, for example, comprise a thin foil of the brazing alloy, which may be, e.g., a copper-phosphorus alloy or a copper-phosphorus-silver alloy. In some cases, the metallic layer may be coated with or otherwise include a flux.

Another aspect of the invention relates to a method. The method comprises sealing a joint between two pipes with a metallic sealing tape. The metallic sealing tape includes a metallic layer comprising a brazing alloy, and a layer of pressure-sensitive adhesive on one side of the metallic layer. The method also comprises brazing the joint without removing the metallic sealing tape. The brazing may involve heating metallic sealing tape. The brazing may also include adding additional filler metal to the joint using, e.g., a brazing rod.

Other aspects, features, and advantages of the invention will be set forth in the description that follows.

### BRIEF DESCRIPTION OF THE DRAWING FIGURES

The invention will be described with respect to the following drawing figures, in which like numerals represent like features throughout the description, and in which:

FIG. 1 is a cross-sectional view of a metallic sealing tape according to an embodiment of the invention;

FIG. 2 is a flow diagram of a method for using the metallic sealing tape of FIG. 1; and

FIG. 3 is a perspective view of a piping system illustrating the use of the metallic sealing tape.

### DETAILED DESCRIPTION

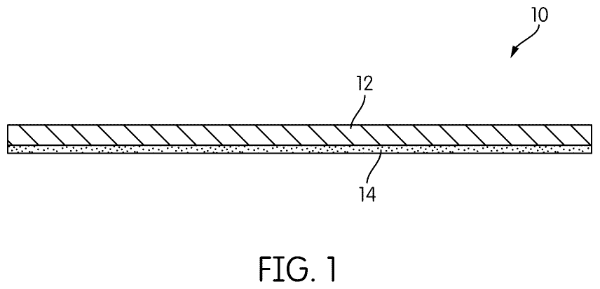

FIG. 1 is a cross-sectional view of a metallic sealing tape, generally indicated at 10, according to one embodiment of the invention. The metallic sealing tape 10 has two layers: a thin metallic layer 12 and a layer of pressure-sensitive adhesive 14.

The metallic layer 12 is made of a brazing metal or metal alloy, such as a copper-phosphorus or a copper-phosphorus-silver alloy. The properties of the alloy will depend on the application. For example, in medical gas plumbing applications, the metallic layer 12 may have a melting temperature at or above 538° C. (1000° F.). As will be described below in more detail, the metallic layer 12 should be thin and malleable enough that the tape 10 can be wrapped around a pipe and can contour around the contours of the pipe and the joint. In one embodiment, for example, the metallic layer 12 may be a foil with a thickness of, e.g., 0.20 to 0.5 mm (about 9 to 20 mils).

The properties of the pressure-sensitive adhesive 14 will also vary somewhat with the application. Generally speaking, the pressure-sensitive adhesive 14 should be capable of adhering to copper, copper alloys, and other metals used in plumbing. It may, in some embodiments, be relatively tacky. Adhesive strength should be sufficient to make a seal at a joint with at least a low-pressure gas flow within the pipe, e.g., 35-70 kPa (5-10 psi). The chemistry of the pressure-sensitive adhesive 14 may vary from embodiment to embodiment. For example, the pressure-sensitive adhesive 14 may be a rubber-based adhesive, an acrylic adhesive, or a silicone-based adhesive. In fact, the pressure-sensitive adhesive 14 may be the same as or similar to known pressure-sensitive adhesives used on common electrical tape. The pressure-sensitive adhesive 14 may be covered by a protective release liner from which it releases easily, e.g., of coated paper or polyethylene, to name but a few options.

As will be described below in more detail, when the metallic sealing tape 10 is used, it will most often be brazed into the joint to which it is initially attached. Thus, the metallic layer 12 may be modified to improve its wetting properties. For example, a brazing alloy with good wetting properties may be chosen. Additionally or alternatively, the metallic layer 12 could be coated with a layer of flux to improve wetting.

Moreover, while a thin, metallic foil is one possible form of the metallic layer 12, the metallic layer 12 may be implemented in various other ways. For example, the metallic layer 12 could be comprised of brazing alloy particles in an appropriate binder, or it could be comprised of a composite of brazing alloy particles and flux particles in an appropriate binder. The pressure-sensitive adhesive 14 and any binder used in the metallic sealing tape 10 preferably burn off cleanly at no more than the melting temperature of the metallic layer 12.

The metallic sealing tape 10 may be of any desirable width, ranging from, e.g., about 6 mm (0.25 inches) to about 150 mm (about 6 inches). Most embodiments of the metallic sealing tape 10 may be in the range of about 25-50 mm (i.e., about 1-2 inches) in width. The metallic sealing tape 10 may be in the form of a roll with, e.g., a cardboard or plastic core. As was noted above, the pressure-sensitive adhesive 14 may be protected by a release liner. Especially if the metallic layer 12 of the metallic sealing tape 10 is covered by or impregnated with a flux, a release liner may be helpful to prevent interaction between the adhesive 14 of one layer of the tape 10 and the metallic layer 12 of another layer of the tape 10.

The metallic layer 12 may also be coated, dyed, or impregnated with a pigment. The pigment would typically be of a saturated, easily-noticeable color, such as red, blue, yellow, green, pink, orange, etc. If present, the pigment would make it obvious when the metallic sealing tape 10 is used around a joint.

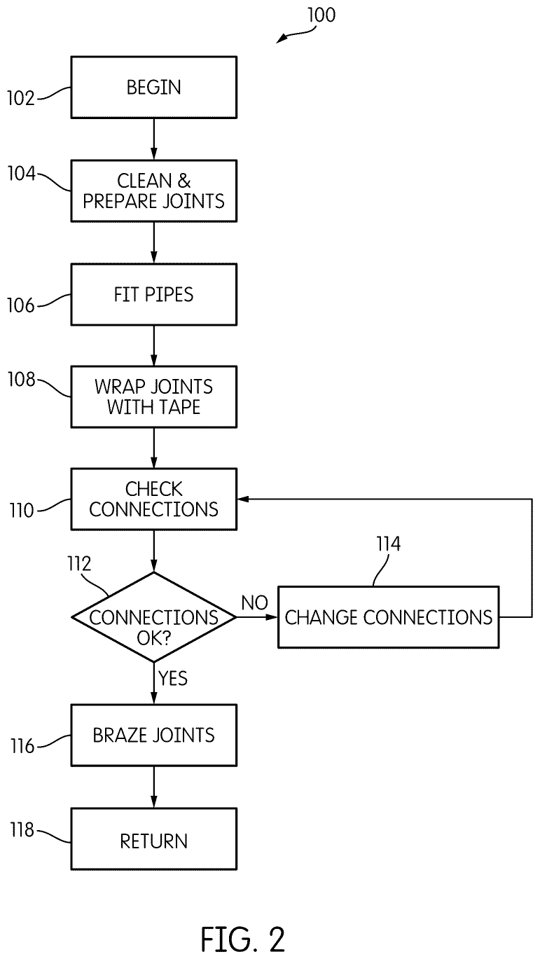

FIG. 2 is a flow diagram of a method, generally indicated at 100, for using the metallic sealing tape 10. As those of skill in the art will appreciate, the description of method 100 pertains particularly to the use of the metallic sealing tape 10. Tasks not described here, or described only briefly, may be assumed to be performed in accordance with customary plumbing practices, local building codes, or national standards, whichever is controlling in a particular application.

Method 100 begins at 102 and continues with task 104. In task 104, pipe-ends and fittings are cleaned and prepared for joining and brazing. This may be done by mechanical abrasion of the surfaces to remove oxides and to reveal bright copper, or it may be done by application of a flux. The remainder of this description will assume that task 104 is done mechanically, rather than with a flux. Method 100 continues with task 106.

In task 106, the joints are fitted together. This is typically done by manually inserting pipes into fittings. Once the joints are fitted together, method 100 continues with task 108.

In task 108, the metallic sealing tape 10 is fit around each joint. This may be done by wrapping the metallic sealing tape 10 around the joint. The particular metallic sealing tape 10 that is used will usually be wide enough to cover the joint and some space around it. The metallic sealing tape 10 may be wrapped once around the joint with a small overlap between the ends, or it may be wrapped multiple times around the joint. The installer may apply manual pressure to cause the pressure-sensitive adhesive 14 to adhere to the substrate, or a tool, such as a roller, may be used to smooth and press the metallic sealing tape 10 against the joint.

In some cases, tasks 102-108 may be done in sequence for one joint at a time. That is, one joint may be cleaned, fit together, and taped before moving on to another joint. In other cases, a task 102, 104, 106, 108 may be performed for each joint in the system before moving on to the next task. That is, every joint may be cleaned before any joint is fit together, and all joints may be fit together before any joint is taped. This choice will depend on codes and the installer's judgment.

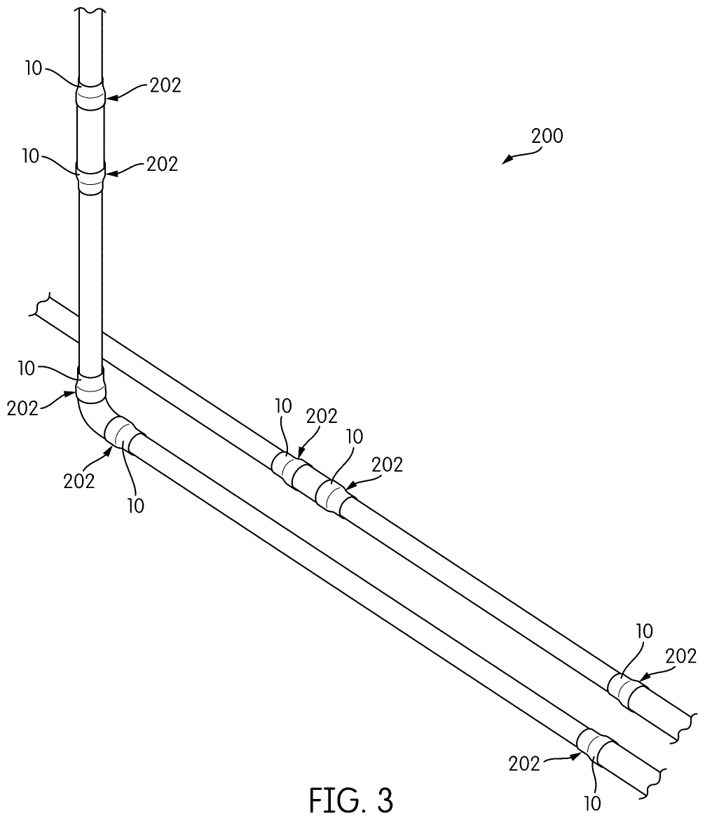

After task 108, a piping system has been fit together and taped with the metallic sealing tape 10. FIG. 3 is a perspective view showing a piping system, generally indicated at 200, with a number of joints 202. The joints 202 are wrapped, as shown, with metallic sealing tape 10.

With respect to method 100 of FIG. 2, once the piping system 200 is assembled in this way, the plumber can test the system to ensure that the connections are proper (i.e., the correct pipes are connected together and gas flows go where they are intended to go), as indicated in task 110. Prior to any kind of functional testing or use, task 110 may also include checking the joints 202 to ensure that the metallic sealing tape 10 is properly wrapped around each. If a pigment is used in or on the metallic layer 12, this may involve inspecting the joints 202 for the color of the pigment.

Task 110 is an optional task and may not be necessary in all implementations of method 100. If, for some reason, the pipes are misconnected or there is some other reason why the piping system 200 needs to be reconfigured, the metallic sealing tape 10 can be removed, the pipes reconnected as needed, and new metallic sealing tape 10 can be used to make a seal around the joint. (In some cases, a length of metallic sealing tape 10 may be re-used, depending on the condition of the tape 10, the condition of the pressure-sensitive adhesive 14, and other factors.) If the metallic sealing tape 10 is removed, the joint 202 may be cleaned mechanically or chemically to remove any adhesive residue in order to ensure that new tape 10 adheres well.

Task 112 is a decision task. If the plumber is not satisfied with the connections (task 112: NO), method 100 continues with task 114 and corrective action is taken in task 114 and method 100 returns to task 110. If the plumber is satisfied with the connections (task 112: YES), method 100 proceeds directly with task 116—brazing.

In task 116, the piping system 200 is brazed. Notably, this is done without removing the metallic sealing tape 10 from the joints. Thus, compared to the standard process using electrical tape, method 100 omits a step because there is no need for it.

When the metallic sealing tape 10 is heated with a torch or with other appropriate heating means, the metallic layer 12 of the tape 10 liquefies and flows into and around the joint. The pressure-sensitive adhesive 14 will typically burn off at brazing temperatures, leaving only the brazing alloy of the metallic layer 12. If the metal of the metallic layer 12 is not sufficient to braze and seal the joint by itself, additional filler metal can be added using traditional brazing rod or filler metal in some other form. Task 116 may be performed with low-pressure dry nitrogen flowing through the joint, or in any other fashion dictated by codes or standards.

Method 100 completes at 118.

While the invention has been described with respect to certain embodiments, the description is intended to be exemplary, rather than limiting. Modifications and changes may be made within the scope of the invention, which is defined by the appended claims.

What is claimed is:

1. A metallic sealing tape, including:
a metallic layer comprising a brazing alloy; and
a layer of pressure-sensitive adhesive on one side of the metallic layer.

2. The metallic sealing tape of claim 1, wherein the metallic layer comprises a foil of the brazing alloy.

3. The metallic sealing tape of claim 1, wherein the brazing alloy comprises a copper-phosphorus alloy or a copper-phosphorus-silver alloy.

4. The metallic sealing tape of claim 1, wherein the metallic later is coated with or includes a flux.

5. The metallic sealing tape of claim 1, wherein the metallic layer is coated, impregnated, or dyed with a pigment.

6. A method, comprising:
sealing a joint between two pipes with a metallic sealing tape including a metallic layer comprising a brazing alloy and a layer of pressure-sensitive adhesive on one side of the metallic layer by wrapping the metallic sealing tape around the joint; and
brazing the joint without removing the metallic sealing tape.

7. The method of claim 6, wherein said brazing further comprises heating the metallic sealing tape.

8. The method of claim 7, further comprising, during said brazing, adding additional filler metal.

9. The method of claim 8, wherein said adding is performed with brazing rod.

10. The method of claim 6, further comprising flowing a gas through the joint during said brazing.

11. The method of claim 6, wherein the metallic layer of the metallic sealing tape comprises a foil of the brazing alloy.

12. The method of claim 6, wherein the brazing alloy comprises a copper-phosphorus alloy or a copper-phosphorus-silver alloy.
